(19) United States
(12) Patent Application Publication
(10) Pub. No.: US 2020/0391416 A1
(43) Pub. Date: Dec. 17, 2020

(54) BLOWING AGENT INTRODUCTION IN POLYMER FOAM PROCESSING METHODS AND SYSTEMS

(71) Applicant: Trexel, Inc., Wilmington, MA (US)

(72) Inventors: Theodore A. Burnham, Melrose, MA (US); Brian S. Cockell, North Andover, MA (US); Levi A. Kishbaugh, Groveland, MA (US)

(73) Assignee: Trexel, Inc., Wilmington, MA (US)

(21) Appl. No.: 16/440,370

(22) Filed: Jun. 13, 2019

(51) Int. Cl. B29C 44/34; B29C 44/32; B29C 45/16; B29C 45/18; B32B 5/18; B32B 27/06

(52) U.S. Cl. CPC B29C 44/3449; B29C 44/32; B29C 45/16; B29K 2101/12; B32B 5/18; B32B 27/065; B29C 45/1816

(57) ABSTRACT

Blowing agent introduction polymeric foam processing methods and systems are described herein.

### FIELD The present invention relates generally to polymer foam processing and, more particularly, to blowing agent introduction polymeric foam processing methods and systems.

### BACKGROUND

Polymeric materials are processed using a variety of techniques. Many techniques employ an extruder which includes a polymer processing screw that rotates within a barrel to plasticate polymeric material. Some processing techniques, such as injection molding, may be discontinuous. That is, during operation, the screw does not plasticate polymeric material continuously. Discontinuous processes may have repetitive molding cycles which include a plastication period, in which the screw rotates and polymeric material is accumulated, followed by an injection period, in which the screw does not rotate and the accumulated polymeric material is injected into a mold.

Polymeric foams include a plurality of voids, also called cells, in a polymer matrix. Microcellular foams are a type of polymeric foam that are characterized by very small cell sizes.

Polymeric foams (including microcellular foams) are processed using a variety of techniques. For example, polymeric foams can be processed by injecting a physical blowing agent into the polymeric material during a plastication period. For instance, many conventional systems inject blowing agent through a blowing agent port in the barrel of the extruder into a fluid stream of polymeric material within the extruder. The blowing agent may be mixed with the polymeric material to form a mixture (e.g., a single-phase solution) within the extruder. The mixture may be, for example, injected into a mold to form an injection molded polymeric foam article.

In general, blowing agent introduction in certain discontinuous processes can lead to problems, in particular, for processes that rely on precise control over blowing agent introduction. For example, it may be difficult to precisely control the concentration and/or distribution of blowing agent during different plastication periods of a molding cycle. This can lead to inconsistencies and other problems.

Accordingly, there is a need for blowing agent introduction techniques that address the above-noted problems.

### SUMMARY

Blowing agent introduction polymeric foam processing methods and systems are described herein.

In an aspect, a method is provided. The method comprises plasticating polymeric material in an extruder in a plastication period of a first molding cycle and introducing a first dose of blowing agent into the polymeric material during the plastication period of the first molding cycle. The method further comprises accumulating a first shot comprising blowing agent and polymeric material and injecting the first shot into a first mold during an injection period of the first molding cycle to form a first polymeric foam article. The method further comprises plasticating polymeric material in an extruder during a plastication period of a second molding cycle and introducing a second dose of blowing agent into the polymeric material during a plastication period of the second molding cycle. A mass of the second dose is pre-selected and controlled to have a different mass than the first dose by at least 5%. The method further comprises accumulating a second shot comprising blowing agent and polymeric material and injecting the second shot into a second mold during an injection period of the second molding cycle to form a second polymeric foam article.

In an aspect, a system is provided. The system comprises a mold and an extruder including a screw configured to rotate in a barrel during a plastication period of a first molding cycle to convey a mixture of polymeric material and blowing agent in a downstream direction in the extruder. After a first shot of the mixture is accumulated, the screw is configured to move in a downstream direction in the extruder during an injection period of the first molding cycle to inject the first shot into the mold. After injecting the first shot into the mold, the screw is configure to rotate in the barrel during a plastication period of a second molding cycle to convey a mixture of polymeric material and blowing agent in the downstream direction in the extruder. After the second shot of the mixture is accumulated, the screw is configured to move in the downstream direction in the extruder during an injection period of the second molding cycle to inject the second shot into the mold. The system comprises at least one processor and at least one storage medium having encoded thereon executable instructions that, when executed by the at least one processor, cause the at least one processor to carry out a method. The method comprises introducing a first dose of blowing agent into the polymeric material during a plastication period of a first molding cycle and introducing a second dose of blowing agent into the polymeric material during a plastication of a second molding cycle, wherein the second dose is pre-selected and controlled to have a different mass than the first dose by at least 5%.

Other aspects and features will become apparent from the following detailed description of the invention when considered in conjunction with the accompanying drawings.

### BRIEF DESCRIPTION OF THE DRAWINGS

FIG. 1 schematically illustrates a polymer foam processing system according to an embodiment.

FIG. 2 schematically illustrates a computing device suitable for use in connection with a polymer foam processing system according to an embodiment.

### DETAILED DESCRIPTION

Methods and systems are described herein which involve introducing blowing agent into polymeric material that is processed in an extruder to form polymeric foam articles (e.g., injection molded foam articles). A blowing agent introduction system may be configured to control the amount of physical blowing agent (e.g., nitrogen, carbon dioxide) introduced into the polymeric material being processed. In particular, the system may be configured to introduce different blowing agent doses during respective plastication periods of a molding cycle. As described further below, the system may introduce a blowing agent dose in a plastication period having a certain mass and may introduce a blowing dose having a different mass (e.g., greater or less) in the subsequent plastication period. The mass of the dose(s) may be pre-selected and controlled. Such ability to vary in a controlled manner the mass of the dose being introduced in different plastication periods can lead to a number of advantages including better control of blowing agent concentration and/or distribution during shots in processes that utilize different shot sizes which can improve the quality of the resulting injection molded foam articles. In some embodiments, the blowing agent introduction system may also be coupled (e.g., via a control system) to the mold to control pre-pressurization and venting of the mold cavity which can aid in controlling the foaming process.

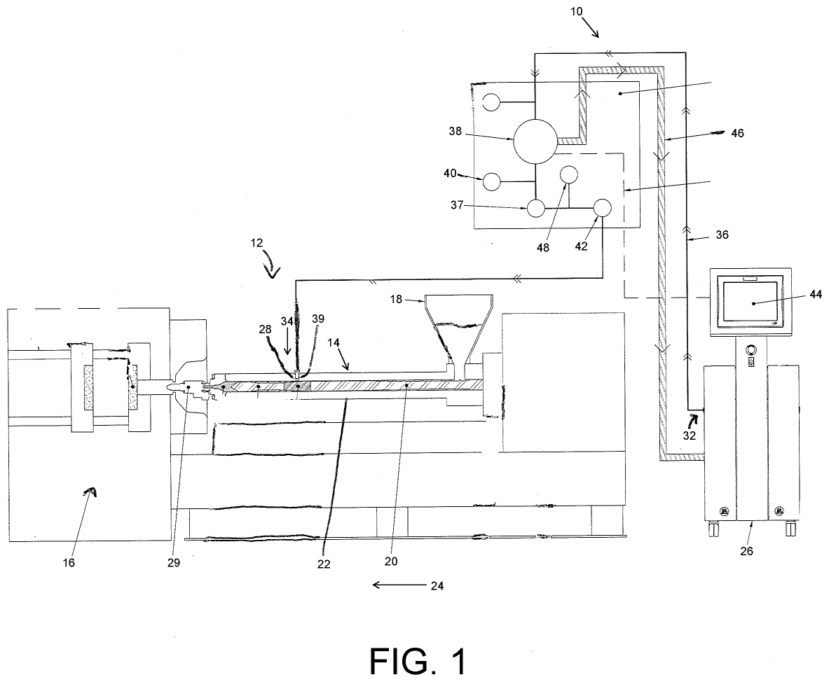

Referring to FIG. 1, a polymer foam processing system 12 is schematically shown. The system includes a blowing agent introduction system 10 used to deliver physical blowing agent (e.g., nitrogen and/or carbon dioxide). In this embodiment, the system is an injection molding system that includes an extruder 14 and a mold 16. As described further below, the blowing agent introduction system may be coupled to the mold as shown.

A hopper 18 provides polymeric material (e.g., in the form of pellets) to the extruder. The extruder includes a screw 20 designed to rotate within a barrel 22 to plasticate polymeric material. Heat (e.g., provided by heaters on the extruder barrel) and shear forces (e.g., provided by the rotating screw) act to melt the polymeric material to form a fluid polymeric stream. The stream is conveyed in a downstream direction 24 by the rotation of the screw.

It should be understood that the polymer foam processing system may include a number of conventional components not illustrated in the figure.

In the illustrated embodiment, the blowing agent introduction system includes a physical blowing agent source 26 (e.g., nitrogen, carbon dioxide) that is connected to one or more port(s) 28 in the barrel of the extruder. The system is configured to control the flow of physical blowing agent from the source to introduce a dose of blowing agent into the fluid polymeric stream. As used herein, the term “dose” refers to the mass of blowing agent that is introduced during a plastication period of a molding cycle.

The location on the screw at which blowing agent is introduced is referred to herein as a blowing agent receiving section. The screw may include sections specifically designed to receive blowing agent and/or mix blowing agent (e.g., in a mixing section) downstream of the introduction location.

The polymeric material and blowing agent mixture is conveyed in a downstream direction in the extruder barrel by rotation of the screw. In some embodiments, for example when microcellular polymeric foam articles are produced, the mixture is a single-phase solution with the physical blowing agent being dissolved in the polymeric material prior to injection into the mold.

A shot of the mixture (e.g., single-phase solution) can be accumulated downstream of the screw within the extruder causing the screw to retract in an upstream direction within the barrel. When suitable conditions have been reached (e.g., after a predetermined time period, at a predetermined screw position, etc.), the screw stops retracting and rotating to end the plastication period of the molding cycle. During the injection period of the molding cycle, the screw may be forced downstream within the barrel to an injection position to inject the shot of the mixture into a cavity of the mold while a valve 29 associated with the outlet of the extruder is opened. The mixture is subjected to a pressure drop during injection which nucleates a large number of cells and a polymer foam article is formed in the mold.

It should be understood that a molding cycle may include other time periods in addition to the plastication period and the injection period such as time periods of cooling, mold opening and part removal, amongst others.

The screw may begin to rotate once again to begin the plastication period of another molding cycle. As described further below, the blowing agent introduction system may be configured to introduce a dose of blowing agent (e.g., a second dose) that is different than the blowing agent dose (e.g., first dose) that was introduced during the previous plastication period. The dose(s) of blowing agent may be pre-selected and their introduction may be controlled, as described herein. In some embodiments, the second dose may have a mass that is at least 5% different (greater or less) than the mass of the first dose; in some embodiments, the second dose may have a mass that is at least 10% different (greater or less) than the mass of the second dose; and, in some embodiments, the second dose may have a mass that is at least 15% different (greater or less) than the mass of the first dose; and, in some embodiments, the second dose may have a mass that is at least 20% different (greater or less) than the mass of the first dose. In some embodiments, the second dose may have a mass that is at most 30% different (greater or less) than the mass of the first dose; and, in some embodiments, the second dose may have a mass that is at most 25% different (greater or less) than the mass of the first dose.

In some embodiments, the mass of the shot(s) and/or dose(s) may be programmed into the blowing agent introduction system and/or a control system of the blowing agent introduction system. In some embodiments, the control system may also control other components of the polymer foam processing system. In some cases, the mass of the shot(s) and/or dose(s) may be manually entered. In some cases, the mass of the shot(s) and/or dose(s) may be determined from other inputs (e.g., desired weight percentage of blowing agent, desired shot size, etc.). In some cases, the mass of the shot(s) and/or dose(s) may be selected from a library of different (e.g., pre-stored) recipes that are programmed into the blowing agent introduction system and/or a control system based on input(s) received by the blowing agent introduction system and/or control system. In some embodiments, the mass of the shot(s) may be communicated to the blowing agent introduction system (e.g., a control system) by an RFID chip coupled to the mold.

In general, the mass of blowing agent in a dose is selected to provide a desired blowing agent concentration of blowing agent in the polymeric material. For example, the blowing agent concentration in a shot (i.e., mass of blowing agent divided by mass of polymeric material in shot) may be less than about 5%; in other embodiments, less than about 3%; in other embodiments less than about 1%; in other embodiments, less than about 0.5%; and, still other embodiments, less than about 0.1%. In some embodiments, the blowing agent concentration in a shot may be greater than about 0.05%.

In some embodiments, the mass of at least one (or both) of the blowing agent doses is between 1 g and 15 g; in some embodiments, the mass of at least (or both) one of the blowing agent doses is between 1 g and 10 g; and, in some embodiments, the mass of at least one (or both) of the blowing agent doses is between 1.5 g and 3.5 g.

In some embodiments, the blowing agent shot is introduced into the polymeric material during substantially the entire duration of the plastication period(s). In other embodiments, the blowing agent shot is introduced into the polymeric material during only a portion of the duration of the plastication period(s). For example, the blowing agent shot may be introduced during 75% or less of the plastication period.

The blowing agent shot is generally introduced continuously into the polymeric material during the plastication period. However, it should be understood that the methods described herein are not limited to continuous introduction. For example, blowing agent may be introduced discontinuously during the plastication period with the mass of the shot equaling the total mass of blowing agent introduced during the plastication period

In some embodiments, the blowing agent is introduced into the polymeric material at a relatively constant rate during the plastication period. In other embodiments, the rate of blowing agent introduction into the polymeric material may vary during a plastication period.

The blowing agent introduction system includes a blowing agent source 26 connectable to one or more port(s) 28 that are formed in the barrel of the extruder. During an illustrative process, the source provides blowing agent to the introduction system. The source may supply any type of physical blowing agent known to those of ordinary skill in the art including nitrogen, carbon dioxide, hydrocarbons, chlorofluorocarbons, noble gases and the like or mixtures thereof.

The blowing agent may be supplied in any flowable physical state such as a gas, a liquid, or a supercritical fluid. According to one preferred embodiment, the source provides nitrogen as a blowing agent. In another preferred embodiment, the source provides carbon dioxide as a blowing agent. In certain embodiments, solely carbon dioxide or nitrogen is used. Blowing agents that are in the supercritical fluid state after injection into the extruder, (optionally, before injection as well) and in particular supercritical carbon dioxide and supercritical nitrogen, are preferred in certain embodiments.

As described further below, conduit 36 is used to connect various components of the introduction system and to provide a pathway from the source to the blowing agent port(s). In some embodiments, the blowing agent introduction system includes other components such as a pressure regulator 38 which may be used to set the pressure of blowing agent. In some embodiments, the blowing agent introduction system may include an accumulator 47 connected to an interchangeable bottle of blowing agent. In some embodiments, such as when a bottle does not supply blowing agent at a sufficiently high pressure, a pump may be connected to increase and/or maintain pressure of blowing agent in the introduction system.

The blowing agent introduction system may include a metering device connected to an outlet of the source to monitor and control the flow rate of blowing agent supplied by the source. Metering device may be any of the type known in the art. In some embodiments, the metering device meters the mass flow rate of the blowing agent. In these embodiments, the mass flow rate of the blowing agent supplied by the source may be varied over a wide range as required by the particular process. For example, the blowing agent mass flow rate is generally between about 0.001 lbs/hr and 100 lbs/hr, in some cases between about 0.002 lbs/hr and 60 lbs./hr, and in some cases between about 0.02 lbs./hr and about 10 lbs./hr.

The blowing agent introduction system also may include an injector valve positioned between the source and port. When the injector valve is in an open configuration, the flow of blowing agent from the source to the polymeric material in the extruder is stopped. When the injector valve is in an open configuration, blowing agent from the source is permitted to flow through the valve and into the polymeric material in the extruder. Therefore, the injector valve may be used to selectively control the introduction of blowing agent into the polymeric material in the system.

It should be understood that the blowing agent introduction system may include other standard components such as valves which may be used to selectively control blowing agent flow therepast.

In one illustrative embodiment, the blowing agent introduction system includes an upstream end 32 connectable to source 26 and a downstream end 34 connectable to port(s) 28. Conduit 36 extends from the upstream end to the downstream end to connect various components of the introduction system and to provide a pathway from the source to the blowing agent port. The blowing agent introduction system may include a flow restrictor 37 through which blowing agent passes when flowing from the source to the blowing agent port. Upstream of the flow restrictor, the blowing agent introduction system may include a pressure regulator 38 and an upstream pressure measuring device 40. Downstream of the flow restrictor, the blowing agent introduction system may include a downstream pressure measuring device 42. A controller 44 of the blowing agent introduction system may be operably connected to the measuring devices and regulators, so that the controller may receive inputs from the measuring devices and can provide outputs to control the regulator. As shown, the system includes a return pathway 46 with an inlet upstream of the flow restrictor that enables blowing agent to flow back to the source when the blowing agent is not being introduced into the extruder.

In some embodiments and as shown, the blowing agent introduction system may optionally include one or more temperature measuring device 48. For example, temperature measuring device(s) may be positioned at one or more of the following locations: at or proximate the flow restrictor, upstream of the flow restrictor, or downstream of the flow restrictor. The temperature measuring device(s) may also be operatively connected to the controller so that the controller is responsive to inputs from the temperature measuring devices.

In some cases, the blowing agent introduction system may include a temperature controlling device (not illustrated). Such temperature controlling devices may be employed to heat or cool the blowing agent to a desired temperature. The temperature controlling devices may be located at one or more of the following locations: at or proximate the flow restrictor, upstream of the flow restrictor, or downstream of the flow restrictor. Temperature controlling devices are not used in many embodiments.

To measure the amount (e.g., mass) of blowing agent introduction (e.g., in a plastication period) and/or otherwise control blowing agent introduction, the blowing agent introduction system can utilize a relationship between the blowing agent pressure differential across the flow restrictor, the dimensions of the flow restrictor, the flow rate of blowing agent and, in some cases, the temperature of the blowing agent. Such a relationship may be pre-determined for a given flow restrictor using a calibration procedure. One suitable calibration procedure involves measuring the flow rate through the flow restrictor at a number of different pressure and temperature conditions. The dependency of flow rate on the flow restrictor dimensions and other measured variables may be determined, for example, using regression analysis as known to those of ordinary skill in the art. The measured variables may include pressure differential across the flow restrictor, upstream pressure, downstream pressure, and temperature of the blowing agent at one or more locations. In some embodiments, the relationship may be used by the controller to determine the amount of blowing agent introduced (e.g., in a plastication period) and/or how to regulate the pressure upstream of the flow restrictor to provide a desired blowing agent flow volume and/or rate in response to inputs from the measuring devices (e.g., pressure differential across the flow restrictor, temperature) and manual inputs (e.g., dimensions of the flow restrictor).

During an illustrative process, the source provides blowing agent to the introduction system. As blowing agent flows through the conduit, the upstream pressure is measured by device 40, the downstream pressure is measured by device 42, and the temperature of blowing agent at the flow restrictor is measured (optionally) by device 48. The pressure and temperature measuring devices send input signals to the controller. The controller processes such input signals along with other input signals (e.g., relating to screw position and operation, time in cycle, etc.), and sends suitable output signals to control operation of the pressure regulator. For example, when the screw begins to rotate at the onset of the plastication process, the controller sends an output signal to the pressure regulator to set the pressure of the blowing agent upstream of the flow restrictor to be above that of the pressure downstream of the flow restrictor (and also generally above that of the pressure of polymeric material within the extruder). The pressure regulator may set the pressure to be greater than 300 psi (e.g., between 300-2000 psi, between 300-2500 psi), greater than 500 psi (e.g., between 500-2000 psi, between 500-2500 psi), or greater than 1000 psi (e.g., between 1000-2000 psi, between 1000-2500 psi) that of the blowing agent pressure downstream of the flow restrictor (and/or pressure of polymeric material within the extruder). At the end of the plastication process and the onset of the injection process, the controller may send an output signal to the pressure regulator to set the pressure of the blowing agent upstream of the flow restrictor to be below that of the blowing agent pressure downstream of the flow restrictor (and/or pressure of polymeric material within the extruder). The pressure regulator may reduce the pressure thereby setting the pressure to be less than 200 psi (e.g., between 200-500 psi), less than 300 psi (e.g., between 300-500 psi), or less than 500 psi (e.g., between 500-700 psi) that of the blowing agent pressure downstream of the flow restrictor (and/or pressure of polymeric material within the extruder). When blowing agent flow to the extruder is prevented, in some embodiments, the flow may be diverted through the return pathway and returned to the blowing agent source.

In some embodiments, the controller processes the input signals and compares the measured pressure differential across the flow restrictor to a desired pressure differential corresponding to a desired blowing agent amount (e.g., mass) and/or flow rate as calculated by the relationship determined during the calibration process described above. The controller may send an appropriate output signal to the upstream pressure regulator to adjust the upstream pressure of the flow restrictor, if necessary, to maintain the desired pressure differential. The flow rate and amount, thus, of blowing agent into the polymeric material within the extruder may be maintained at a selected value to create a mixture of polymeric material and blowing agent having a chosen percentage of blowing agent. Even when the pressure downstream of the flow restrictor changes, for example in response to pressure fluctuations within the polymeric material in the extruder, the introduction system may respond by adjusting the upstream pressure accordingly to provide the selected blowing agent amount and/or flow rate.

As described above, control system 44 of the blowing agent introduction system may receive one or more inputs (e.g., relating to the desired amount of blowing agent introduced into the polymeric material which may be selected by an operator, etc.) and can provide output(s) to control the pressure regulator to supply blowing agent pressure. In particular, the control system may be used to synchronize the operation of the injection molding system and blowing agent introduction. In the illustrated embodiment, the control system may receive inputs (e.g., relating to mold closing, relating to starting of injection period, etc.) and/or may also provide output(s) that can control pre-pressurization and venting of the mold.

The control system may be any of the type known in the art such as a computing device, as described further below. As described above, the control system is capable of receiving input signals (e.g., from a user, from other components of the polymer processing system, etc.) and sending appropriate output signals (e.g., to components of the blowing agent introduction system such as the pressure regulator and/or the polymer processing system, etc.).

As described above, the blowing agent introduction system may be coupled to the mold. For example, the control system of the blowing agent introduction system may be configured to control pre-pressurization and/or venting of the mold cavity.

As noted above, in some embodiments, blowing agent is introduced proximate a blowing agent receiving section of the screw. The blowing agent receiving section is generally positioned beneath the blowing agent port(s) during processing so that this section receives the blowing agent introduced into the processing space. In some embodiments, the receiving section may be referred to as a wiping section that includes a screw flight (e.g., an unbroken screw flight) which passes beneath the blowing agent port (including orifices, if present) to enhance dispersion of blowing agent when introduced into the polymeric material. The wiping section, for example, may have a length of between about one-half and about three times the diameter of the screw.

The screw may also include a mixing section positioned downstream of the blowing agent receiving section. The mixing section enhances the mixing of the blowing agent and polymeric material; the mixing could be distributive or dispersive or any combination of the two. The enhanced mixing may enable formation of a single-phase solution of polymeric material and blowing agent which is desirable for microcellular processing, as noted above. The mixing section may have a variety of suitable designs known in the art. For example, the mixing section may include broken screw flights. Certain known designs of mixing sections are referred to as Maddock, spiral Maddock, pineapple, pin, gear, and kneading mixers (and combinations thereof). The length of the mixing section may be between about 0 and 3 times the screw diameter.

In certain embodiments, the screw is designed to have a restriction element 44 positioned upstream of the blowing agent receiving section (and upstream of the blowing agent port 42 when the screw is mounted within the barrel). The restriction element is configured to restrict (and, in some cases, substantially prevent) the upstream flow of polymeric material and blowing agent mixture in the processing space, while the shot is injected into the mold during the injection period. The restriction element, thus, maintains the pressure of the mixture in the polymer processing space to prevent blowing agent from prematurely coming out of solution. For example, the restriction element may maintain the polymeric material downstream of the restriction element at a pressure of at least 1000 psi throughout the injection cycle; in other cases, at least about 2000 psi; or, at least about 3000 psi throughout the injection cycle.

In some cases, the restriction element is a valve which permits downstream flow of polymeric material therethrough in an open configuration and restricts upstream flow of polymeric material therethrough in a closed configuration. The valve, for example, may move from the closed configuration to the open configuration when the pressure of polymeric material downstream of the valve exceeds the pressure of polymeric material upstream of the valve. Suitable restriction element designs have been described in commonly-owned, U.S. Pat. No. 6,322,347, which is incorporated herein by reference.

As noted above, blowing agent is introduced into the extruder through one or more ports. In general, port(s) are formed at a position in the barrel that enables formation of a homogenous mixture of polymeric material and blowing agent mixture within the polymer processing space prior to injection into the mold. As described above, port(s) may be positioned relative to specific sections of the screw, as described further below It should be understood that other port positions may also be suitable. The introduction of blowing agent through a plurality of ports located at different positions in the barrel, for example, may promote formation of a uniform mixture of polymeric material and blowing agent. When multiple ports are utilized, the ports can be arranged radially about the barrel or axially along the length of the barrel.

In some cases, though not all cases, it may be desirable to introduce blowing agent into the polymeric material in the polymer processing space through a plurality of orifices associated with one or more of the blowing agent ports. Blowing agent introduction through a plurality of orifices, for example, may promote formation of a uniform mixture of polymeric material and blowing agent.

As described above, the system may include a shutoff nozzle valve associated with the outlet of the extruder. During the accumulation of a shot of polymeric material and blowing agent, the shut-off nozzle valve is in a closed configuration to maintain the pressure in the polymeric material/blowing agent mixture sufficiently high within the barrel. The high pressure ensures that blowing agent remains dissolved in a single-phase solution of polymeric material and blowing agent formed within the extruder. The opening of the injection valve permits flow of polymeric material into the mold and nucleation of the mixture upon introduction into the mold. One or more heating units be associated with the shutoff nozzle valve. It should be understood that a shut-off nozzle valve may not be present in certain systems.

In general, the systems and methods may be used to process any suitable type of polymeric material. Suitable materials include thermoplastic polymers which may be amorphous, semicrystalline, or crystalline materials. Typical examples of polymeric materials include styrenic polymers (e.g., polystyrene, ABS), polyolefins (e.g., polyethylene and polypropylene), fluoropolymers, polyamides, polyimides, polyesters, polycarbonate, polyphenylene ether (PPE), thermoplastic elastomers (e.g., thermoplastic urethane (TPU), thermoplastic polyester elastomers, EVA, polyoefin elastomers (POE) and polyether block amides), vinyl halides (e.g., PVC), acrylic (e.g., PMMA), acetal, other high temperature plastics (e.g., PEEK, PEKK, PES, PPS, PEKK, PEI, PPA) and the like. The polymeric material may also include any number of other additives known in the art such as reinforcing agents, lubricants, plasticizers, colorants, fillers, stabilizers and the like. Optionally, the articles may include a nucleating agent, such as talc or calcium carbonate. In many embodiments, the articles are free of a nucleating agent. The articles are generally free of residual chemical blowing agents or reaction byproducts of chemical blowing agents. The articles are also generally free of non-atmospheric blowing agents, for example, when the supercritical fluid additive is an atmospheric gas (e.g., nitrogen, carbon dioxide).

As described above, the systems and methods may be used to form polymeric foam articles. In some embodiments, the systems and methods may be used to form microcellular polymeric foams. Suitable microcellular polymeric foams have been described, for example, in International Publication No. WO 98/31521 (Pierick et. al.), which is incorporated herein by reference. Microcellular foams have small cell sizes and high cell densities. As used herein, the term “cell density” is defined as the number of cells per cubic centimeter of original, unfoamed polymeric material. As used herein, the term “average cell size” is the numerical average of the size of the cells formed in an article. The average cell size can be determined, for example, by scanning electron microscopy (SEM) analysis of a representative area of the article.

In some embodiments, the microcellular foams have an average cell size of less than 100 microns; and, in other embodiments, an average cell size of less than 50 microns. In some of these microcellular embodiments, the cell size may be uniform, though a minority amount of cells may have a considerably larger or smaller cell size. In some cases, different regions of the article may have cells of different size. For example, edge regions of the article may generally have a smaller cell size than interior regions of the article. Furthermore, edge regions may even have no cells while the interior region does.

The polymeric foam articles, including microcellular foam articles, produced using the systems and methods described herein may be produced over a wide range of void fractions. Polymeric foams may be used that have a void fraction of between about 1% and about 99%. In some embodiments, higher density foams are used having a void fraction of less than 50%, in other cases a void fraction of less than 30%, and in some cases a void fraction of between about 5% and about 30%. The particular void fraction will depend upon the application.

Control system 100 may be implemented as computer hardware executing any suitable form of executable instructions as described further below.

Included in the discussion above are descriptions of steps and acts of various control processes included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application. In other implementations, the functional facilities may be adapted to interact with other functional facilities in such a way as form an operating system. In other words, in some implementations, the functional facilities may be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

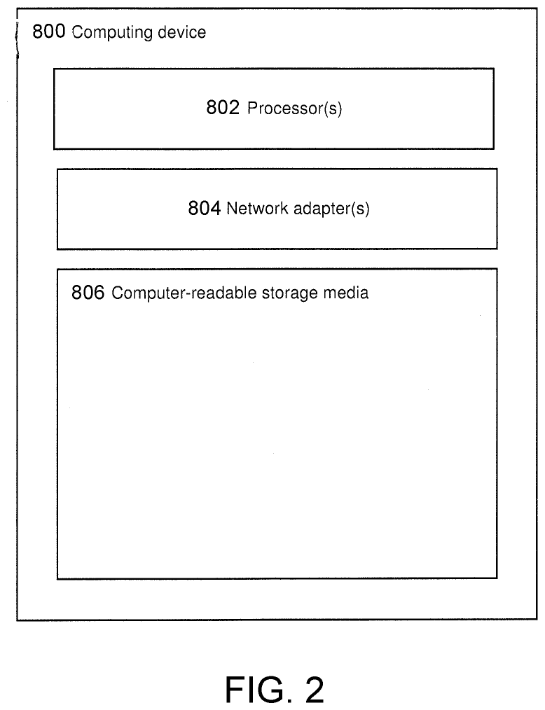

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 806 of FIG. 2 described below (i.e., as a portion of a computing device 800) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 2, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 2 illustrates one exemplary implementation of a computing device in the form of a computing device 800 that may be used in a system implementing techniques described herein, although others are possible. It should be appreciated that FIG. 2 is intended neither to be a depiction of necessary components for a computing device to operate in accordance with the principles described herein, nor a comprehensive depiction.

Computing device 800 may comprise at least one processor 802, a network adapter 804, and computer-readable storage media 806. Computing device 800 may be, for example, a desktop or laptop personal computer, a personal digital assistant (PDA), a smart mobile phone, a server, a wireless access point or other networking element, or any other suitable computing device. Network adapter 804 may be any suitable hardware and/or software to enable the computing device 800 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 806 may be adapted to store data to be processed and/or instructions to be executed by processor 802. Processor 802 enables processing of data and execution of instructions. The data and instructions may be stored on the computer-readable storage media 806.

The data and instructions stored on computer-readable storage media 806 may comprise computer-executable instructions implementing techniques which operate according to the principles described herein. In the example of FIG. 2, computer-readable storage media 806 stores computer-executable instructions implementing various facilities and storing various information as described above. Computer-readable storage media 806 may store the various processes/facilities discussed above.

While not illustrated in FIG. 2, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed:

1. A method comprising:
plasticating polymeric material in an extruder in a plastication period of a first molding cycle;
introducing a first dose of blowing agent into the polymeric material during the plastication period of the first molding cycle;
accumulating a first shot comprising blowing agent and polymeric material;
injecting the first shot into a first mold during an injection period of the first molding cycle to form a first polymeric foam article;
plasticating polymeric material in an extruder during a plastication period of a second molding cycle;
introducing a second dose of blowing agent into the polymeric material during a plastication period of the second molding cycle, wherein a mass of the second dose is pre-selected and controlled to have a different mass than the first dose by at least 5%;
accumulating a second shot comprising blowing agent and polymeric material;
injecting the second shot into a second mold during an injection period of the second molding cycle to form a second polymeric foam article.

2. A system comprising:
a mold;
an extruder including a screw configured to rotate in a barrel during a plastication period of a first molding cycle to convey a mixture of polymeric material and blowing agent in a downstream direction in the extruder and, after a first shot of the mixture is accumulated, the screw being configured to move in a downstream direction in the extruder during an injection period of the first molding cycle to inject the first shot into the mold, and
after injecting the first shot into the mold, the screw being configure to rotate in the barrel during a plastication period of a second molding cycle to convey a mixture of polymeric material and blowing agent in the downstream direction in the extruder and, after the second shot of the mixture is accumulated, the screw being configured to move in the downstream direction in the extruder during an injection period of the second molding cycle to inject the second shot into the mold;
at least one processor; and
at least one storage medium having encoded thereon executable instructions that, when executed by the at least one processor, cause the at least one processor to carry out a method comprising:
introducing a first dose of blowing agent into the polymeric material during a plastication period of a first molding cycle and introducing a second dose of blowing agent into the polymeric material during a plastication of a second molding cycle, wherein the second dose is pre-selected and controlled to have a different mass than the first dose by at least 5%.

3. The method claim 1, wherein the blowing agent comprises carbon dioxide and/or nitrogen.

4. The method claim 1, wherein the first polymeric foam article has a different mass than the second polymeric foam article.

5. The method claim 1, wherein the first polymeric foam article has substantially the same mass as the second polymeric foam article.

6. The method claim 1, wherein the first polymeric foam article has a different void volume than the second polymeric foam article.

7. The method claim 1, wherein the first polymeric foam article has substantially the same void volume as the second polymeric foam article.

8. The method of claim 1, wherein the first polymeric foam article and the second polymeric foam article have an average cell size of less than 100 micron.

9. The method claim 1, wherein the second dose has a different mass than the first dose by at least 10%;

10. The method claim 1, wherein the second dose has a different mass than the first dose by at least 20%;

11. The method of claim 1, wherein the blowing agent concentration in the first dose is substantially the same as the blowing agent concentration in the second dose.

12. The method claim 1, wherein the blowing agent concentration in the first dose is different than the blowing agent concentration in the second dose.

13. The method claim 1, wherein the blowing agent concentration in the first dose is different than the blowing agent concentration in the second dose.

14. The method claim 1, wherein the blowing agent concentration in the first dose and the second dose is less than 1%.

15. The method claim 1, wherein the first shot has a mass that is different than a mass of the second shot.

16. The method claim 1, further comprising programming the mass of the first shot and the mass of the second shot into a control system of a blowing agent introduction system.

17. The method claim 1, further comprising communicating the mass of the first shot and/or the mass of the second shot by an RFID chip on coupled to the mold.

18. The method claim 1, wherein the control system of the blowing agent introduction system is configured to control pre-pressurization and/or venting of the mold cavity.
